(19) United States
(12) Patent Application Publication
(10) Pub. No.: US 2026/0120952 A1
(43) Pub. Date: Apr. 30, 2026

(54) MULTILAYER ELECTRONIC COMPONENT

(71) Applicant: SAMSUNG ELECTRO-MECHANICS CO., LTD., Suwon-si (KR)

(72) Inventors: Bum Soo KIM, Suwon-si (KR); Jae Hoon JI, Suwon-si (KR); Eun Young LEE, Suwon-si (KR); Seung Hun KANG, Suwon-si (KR); Do Hoon KIM, Suwon-si (KR); Kyung Ryul LEE, Suwon-si (KR)

(73) Assignee: SAMSUNG ELECTRO-MECHANICS CO., LTD., Suwon-si (KR)

(21) Appl. No.: 19/318,747

(22) Filed: Sep. 4, 2025

(30) Foreign Application Priority Data
Oct. 29, 2024 (KR) 10-2024-0149793

(51) Int. Cl. H01G 4/12; H01G 4/005; H01G 4/232; H01G 4/248; H01G 4/30

(52) U.S. Cl. CPC H01G 4/1281; H01G 4/005; H01G 4/232; H01G 4/248; H01G 4/30

(57) ABSTRACT

A multilayer electronic component includes: a body including a dielectric layer including as a main component one of SrTiO₃ or TiO₂ in which a donor element is substituted for at least one of the element sites excluding the oxygen element (O), and internal electrodes alternately disposed with the dielectric layer in a first direction; and an external electrode disposed on the body; wherein the dielectric layer includes a plurality of dielectric grains, grain boundaries disposed between adjacent dielectric grains, and triple points disposed at a point at which three or more of the grain boundaries contact each other, a first metal oxide disposed at the triple points, and a second metal oxide disposed at the grain boundaries, wherein an atomic percentage of a first metal element included in the first metal oxide may be higher than an atomic percentage of a second metal element included in the second metal oxide.

### CROSS-REFERENCE TO RELATED APPLICATION(S)

This application claims benefit of priority to Korean Patent Application No. 10-2024-0149793 filed on Oct. 29, 2024 in the Korean Intellectual Property Office, the disclosure of which is incorporated herein by reference in its entirety.

### BACKGROUND

### 1. Field

The present disclosure relates to a multilayer electronic component.

### 2. Description of Related Art

A multilayer ceramic capacitor (MLCC), a multilayer electronic component, may be a chip condenser mounted on the printed circuit boards of various types of electronic product including image display devices such as a liquid crystal display (LCD) and a plasma display panel (PDP), a computer, a smartphone, a mobile phone, or the like, charging or discharge electricity therein or therefrom.

Such a multilayer ceramic capacitor may be used as a component of various electronic devices, since a multilayer ceramic capacitor may have a small size and high capacitance and may be easily mounted. As various electronic devices such as a computer and a mobile device have been designed to have a smaller size and higher output, demand for miniaturization and increased capacitance of a multilayer ceramic capacitor has increased.

Research into new high dielectric constant materials is being conducted due to limitations of dielectric constant and thinning of currently commercialized barium titanate (BaTiO₃) dielectric materials.

As candidates for these new high dielectric constant materials, examples may include materials that have been doped, solid-solubilized, or substituted with donor or acceptor elements such as strontium titanate (SrTiO₃) or titanium dioxide (TiO₂), but there are problems such as high dielectric loss and low resistivity due to doping.

### SUMMARY

An embodiment of the present disclosure is to provide a multilayer electronic component having excellent dielectric properties and improved resistivity properties.

However, the purpose of the present disclosure is not limited to the above-described contents, and may be more easily understood in the process of explaining specific embodiments of the present disclosure.

A multilayer electronic component according to some embodiments of the present disclosure may include: a dielectric layer including, as a main component, one of SrTiO₃ or TiO₂, wherein at least one of an element site excluding oxygen (O) is substituted with a donor element; and a body including internal electrodes alternately disposed with the dielectric layer in a first direction; and external electrodes disposed on the body; wherein the dielectric layer includes a plurality of dielectric grains, grain boundaries between adjacent dielectric grains, and an triple point at a point at which three or more of the grain boundaries contact each other, a first metal oxide disposed at the triple point, and a second metal oxide disposed at the grain boundary, wherein an atomic percentage of a first metal element included in the first metal oxide may be higher than an atomic percentage of a second metal element included in the second metal oxide.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a perspective diagram schematically illustrating a multilayer electronic component according to an embodiment of the present disclosure.

FIG. 2 is an exploded perspective diagram schematically illustrating a laminated structure of an internal electrode.

FIG. 3 schematically illustrates a cross-sectional diagram taken along line I-I′ of FIG. 1.

FIG. 4 schematically illustrates a cross-sectional diagram taken along line II-II′ of FIG. 1.

FIG. 5 is schematically illustrates a cross-sectional diagram taken along line II-II′ of FIG. 1 according to another embodiment of the present disclosure.

FIG. 6 schematically illustrates an enlarged diagram of P region of FIG. 3.

### DETAILED DESCRIPTION

Hereinafter, embodiments of the present disclosure will be described as follows with reference to the attached drawings. The present disclosure may, however, be exemplified in many different forms and should not be construed as being limited to the specific embodiments set forth herein. Rather, these embodiments are provided so that this disclosure will be thorough and complete, and will fully convey the scope of the disclosure to those skilled in the art. Accordingly, shapes and sizes of elements in the drawings may be exaggerated for clear description, and elements indicated by the same reference numerals are the same elements in the drawings.

In the drawings, irrelevant descriptions will be omitted to clearly describe the present disclosure, and to clearly express a plurality of layers and areas, thicknesses may be magnified. The same elements having the same function within the scope of the same concept will be described with use of the same reference numerals. Throughout the specification, when a component is referred to as “comprise” or “comprising,” it means that it may further include other components as well, rather than excluding other components, unless specifically stated otherwise.

In the drawings, a first direction may be defined as a lamination direction or a thickness (T) direction, a second direction may be defined as a length (L) direction, and a third direction may be defined as a width (W) direction.

### Multilayer Electronic Component

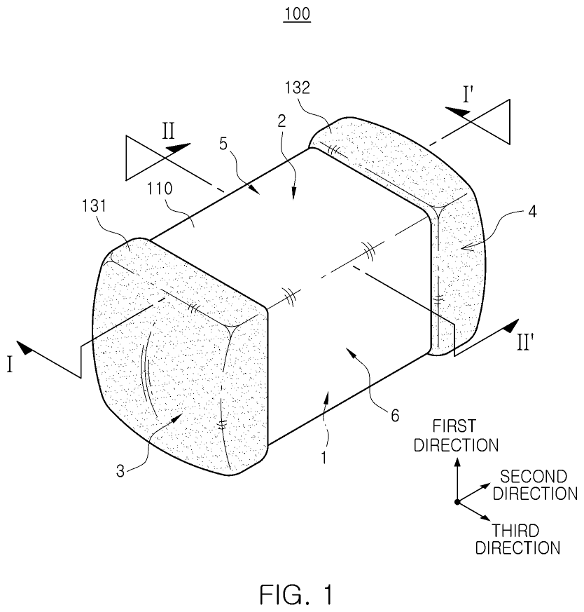

FIG. 1 is a perspective diagram schematically illustrating a multilayer electronic component according to an embodiment of the present disclosure.

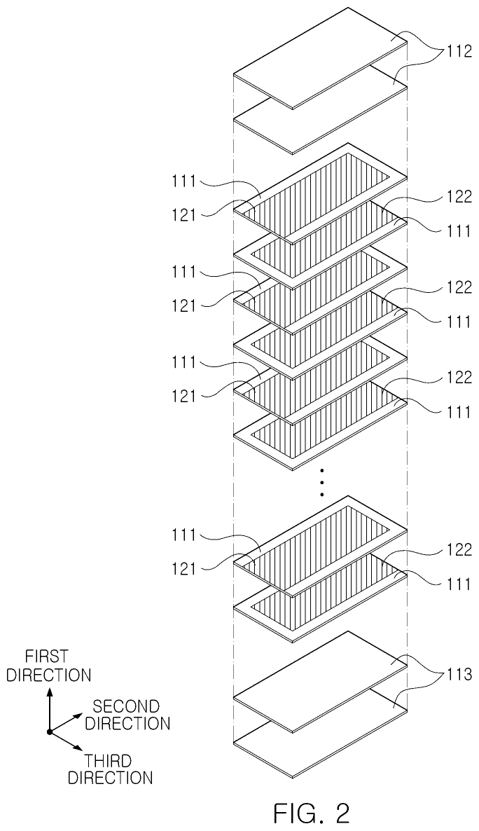

FIG. 2 is an exploded perspective diagram schematically illustrating a laminated structure of an internal electrode.

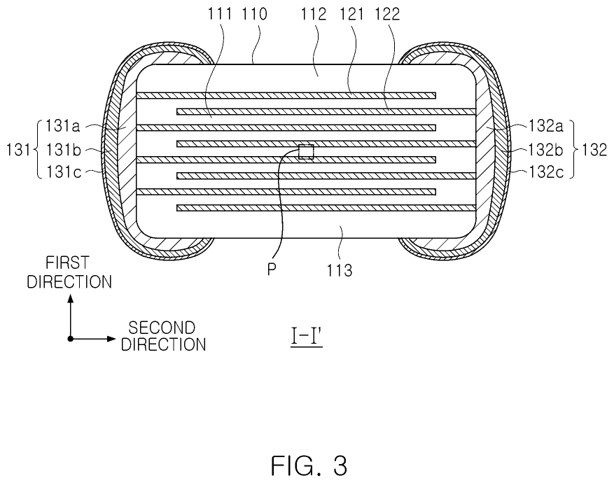

FIG. 3 schematically illustrates a cross-sectional diagram taken along line I-I′ of FIG. 1.

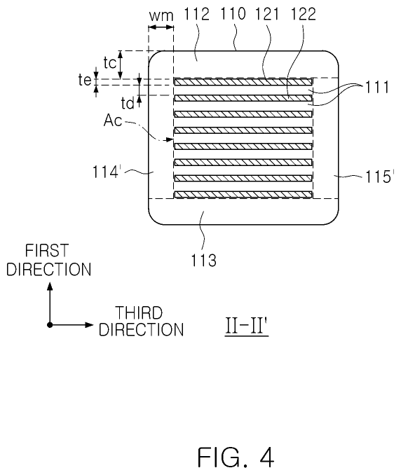

FIG. 4 schematically illustrates a cross-sectional diagram taken along line II-II′ of FIG. 1.

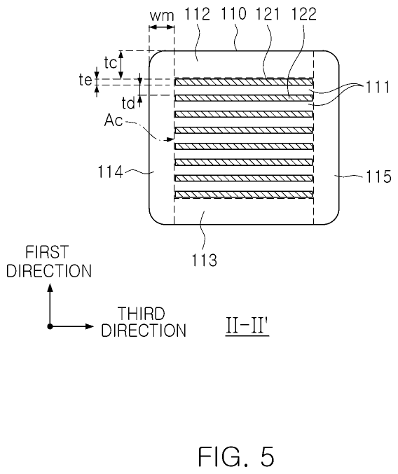

FIG. 5 is schematically illustrates a cross-sectional diagram taken along line II-II′ of FIG. 1 according to another embodiment of the present disclosure.

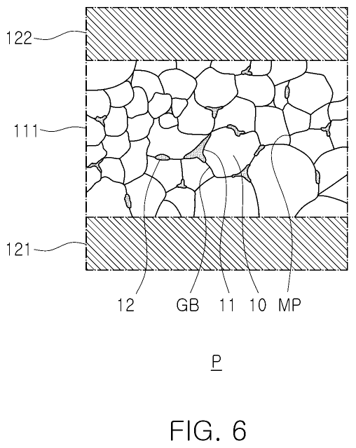

FIG. 6 schematically illustrates an enlarged view of P region of FIG. 3.

Hereinafter, a multilayer electronic component according to some embodiments will be described in greater detail with reference to FIGS. 1 to 6. A multilayer ceramic capacitor will be described as an example of a multilayer electronic component, but an embodiment thereof is not limited thereto, and the multilayer ceramic capacitor may be applied to various multilayer electronic components, such as an inductor, a piezoelectric element, a varistor, or a thermistor.

A multilayer electronic component 100 according to some embodiments of the present disclosure may include: a dielectric layer 111 including as a main component one of SrTiO₃ or TiO₂ in which a donor element is substituted for at least one of element sites excluding oxygen element (O), and a body 110 including the dielectric layer (111) and internal electrodes (121, 122) alternately disposed in the first direction; and external electrodes 131 and 132 disposed on the body 110, and the dielectric layer 111 includes a plurality of dielectric grains 10, grain boundaries GB between adjacent dielectric grains 10, and triple points MP at a point at which three or more of the grain boundaries GB come into contact, a first metal oxide 11 disposed at the triple points MP and a second metal oxide 12 disposed at the grain boundaries GB, wherein an atomic percentage of a first metal element included in the first metal oxide 11 may be higher than an atomic percentage of a second metal element included in the second metal oxide 12.

The body 110 may have a dielectric layer 111 and internal electrodes 121 and 122, alternately stacked therein.

More specifically, the body 110 may include a capacitance formation portion Ac disposed in the body 110 and forming capacitance including the first internal electrode 121 and the second internal electrode 122 alternately disposed to face each other with the dielectric layer 111 interposed therebetween.

The shape of the body 110 may not be limited to any particular shape, but as illustrated, the body 110 may have a hexahedral shape or a shape similar to a hexahedral shape. Due to reduction of ceramic powder included in the body 110 during a firing process, the body 110 may not have an exactly hexahedral shape formed by linear lines but may have a substantially hexahedral shape.

The body 110 may have the first and second surfaces 1 and 2 opposing each other in the first direction, the third and fourth surfaces 3 and 4 connected to the first and second surfaces 1 and 2 and opposing in the second direction, and the fifth and sixth surfaces 5 and 6 connected to the first to fourth surfaces 1, 2, 3, and 4 and opposing each other in the third direction.

A plurality of dielectric layers 111 forming the body 110 may be in a sintered state, and boundaries between the adjacent dielectric layers 111 may be integrated with each other such that boundaries may not be distinct without using a scanning electron microscope (SEM).

Research on new high dielectric constant materials is being conducted due to limitations of dielectric constant and thinning of currently commercialized barium titanate (BaTiO₃) dielectric materials.

As candidates for these new high dielectric constant materials, examples may include materials that have been doped, solid-solubilized, or substituted (hereinafter, “substituted”) with donor or acceptor elements such as strontium titanate (SrTiO₃) or titanium dioxide (TiO₂), but there are problems accompanying defects such as high dielectric loss and low resistivity due to doping.

Accordingly, the multilayer electronic component 100 according to some embodiments of the present disclosure may include the dielectric layer 111 including as a main component one of strontium titanate (SrTiO₃) or titanium dioxide (TiO₂) in which a donor element is substituted for at least one of element sites excluding oxygen element (O).

In some embodiments, the term “main component” may indicate a component occupying a relatively large weight ratio or atomic number ratio as compared to other components, and may indicate a component exceeding 50 wt % based on the weight of the entire composition or the entire dielectric layer, a component exceeding 50 at % based on the number of atoms, or a component exceeding 50 moles % based on the number of moles.

As an example of a more specific method of measuring the content of an element included in each configuration of the multilayer electronic component 100 in embodiments, the component may be analyzed using the energy dispersive X-ray spectroscopy (EDS) mode of a scanning electron microscope (SEM), the EDS mode of a transmission electron microscope (TEM), or the EDS mode of a scanning transmission electron microscope (STEM). First, a thinned analysis sample may be prepared using a focused ion beam (FIB) device in the region to be measured. Thereafter, the surface damage layer of the thinned sample may be removed using xenon (Xe) or argon (Ar) ion milling, and each component to be measured may be mapped from the image obtained using SEM-EDS, TEM-EDS, or STEM-EDS and a qualitative/quantitative analysis may be carried out. In this case, the qualitative/quantitative analysis graph of each component may be represented by converting the content of each element, for example, mass percentage (wt %), atomic percentage (at %), or moles percentage (mol %), and may also represent the content of another specific component for the content of a specific component.

Another method is to crush a chip to select a region to be measured, and then analyze specific components in a portion containing the selected dielectric microstructure using a device such as an inductively coupled plasma optical emission spectrometer (ICP-OES), an inductively coupled plasma mass spectrometer (ICP-MS), or the like.

In addition, a raw material forming the dielectric layer 111 may include various additives, organic solvents, binders, dispersants, or the like, may be added depending on the purpose of embodiments.

Meanwhile, in order to distinguish the dielectric layers included in cover portions 112 and 113 and side margin portions 114 and 115 described below, the dielectric layer 111 included in a capacitance formation portion Ac may be a first dielectric layer 111, the dielectric layer included in the cover portions 112 and 113 may be a second dielectric layer, and the dielectric layer included in the side margin portions 114 and 115 may be a third dielectric layer. However, in the present disclosure, unless specifically contradictory, a content regarding the first dielectric layer may be described as the dielectric layer 111.

In addition, since the first to third dielectric layers may be formed using a dielectric material, the dielectric layers may include a dielectric microstructure after sintering. The dielectric microstructure may include a plurality of dielectric grains, grain boundaries between adjacent dielectric grains, and triple point at a point at which three or more of the grain boundaries contact each other, and may include a plurality of dielectric grains, grain boundaries, and triple points.

Since the dielectric layer 111 includes one of strontium titanate (SrTiO₃) or titanium dioxide (TiO₂) as a main component, in which a donor element is substituted for at least one of element sites excluding the oxygen element (O), a higher dielectric constant may be implemented than a general barium titanate (BaTiO₃) dielectric material.

The donor element may be substituted for the titanium (Ti) element in the case of strontium titanate (SrTiO₃) or for the titanium (Ti) element in the case of titanium dioxide (TiO₂).

Here, the donor element may refer to a +5 element, and more specifically, for example, may include at least one selected from the group consisting of Nb, Ta, Sb, Mo, and V, more preferably at least one of Nb or Ta, but is not particularly limited thereto.

In this case, a content of the substituted donor element may be greater than 0 mol % and less than or equal to 2 mol %.

Here, the content of the substituted donor element (mol %) may refer to a mole number of the donor element (D) relative to the sum (B+D) of a mole number of the element being substituted (B) and a mole number of the substituted donor element (D), expressed as a percentage ([D/(B+D)] %).

For specific example, when the substituted donor element is niobium (Nb) element and the content of the substituted niobium (Nb) element is 1 mol %, it may mean that 1 mol out of 100 mol of titanium (Ti) element is substituted with niobium (Nb) element, resulting in 99 mol of titanium (Ti) element and 1 mol of niobium (Nb) element, and it may mean the percentage value [1 mol/(99+1 mol)] % of 1 mol of niobium (Nb) element with respect to the sum (99+1 mol) of 99 mol of titanium (Ti) element and 1 mol of niobium (Nb) element.

When the content of the substituted donor element satisfies a condition of more than 0 mol % and less than or equal to 2 mol %, the dielectric constant of strontium titanate (SrTiO₃) or titanium dioxide (TiO₂) may be further improved.

When the content of the substituted donor element exceeds 2 mol %, it may cause defects, thereby deteriorating dielectric characteristics, and may cause side effects by reducing the dispersibility of a material including the donor element and causing agglomeration. Additionally, it may excessively deteriorate insulating characteristics or cause dielectric loss (tan δ).

Meanwhile, at least one of strontium titanate (SrTiO₃) or titanium dioxide (TiO₂) may further have an acceptor element substituted for at least one of element sites excluding oxygen element (O).

At least one of strontium titanate (SrTiO₃) or titanium dioxide (TiO₂) may have further improved dielectric characteristics compared to a dielectric material in which only the donor element is substituted by further substituting the acceptor element in at least one of element sites excluding the oxygen element (O).

The acceptor element may be substituted for both the strontium (Sr) element site and the titanium (Ti) element site (preferably the titanium (Ti) element site) in the case of strontium titanate (SrTiO₃), and may be substituted for the titanium (Ti) element site in the case of titanium dioxide (TiO₂).

Here, the acceptor element may refer to a +3 valent element, and more specifically, for example, may include at least one selected from the group consisting of Al, Ga, Mg, Zn, Sc, In, Yb, Er and Eu, more preferably at least one selected from the group consisting of Al, Ga and In, but is not particularly limited thereto.

In this case, a content of the substituted acceptor element may be greater than 0 mol % and less than or equal to 1 mol %.

Here, the content (mol %) of the substituted acceptor element may a molar number (A) of the acceptor element relative to a sum of a molar number (B′) of the element being substituted and the molar number (A) of a substituted acceptor element (B′+A), expressed as a percentage ([A/(B′+A)] %).

Meaning of the content (mol %) of the substituted acceptor element is the same as the content (mol %) of the substituted donor element described above, so the explanation is omitted.

When the content of the substituted acceptor element satisfies a range of more than 0 mol % and less than or equal to 1 mol %, the dielectric constant of strontium titanate (SrTiO₃) or titanium dioxide (TiO₂) may be further improved.

When the content of the substituted acceptor element exceeds 1 mol %, it may cause defects, thereby deteriorating dielectric characteristics, and may cause side effects by reducing the dispersibility of a material including the donor element and causing agglomeration. Additionally, it may excessively deteriorate insulating characteristics or cause dielectric loss (tan δ).

Meanwhile, when the donor element and the acceptor element are substituted together in strontium titanate (SrTiO₃) and titanium dioxide (TiO₂), a total content of the substituted donor element and acceptor element may be greater than 0 mol % and less than or equal to 2 mol %.

When the total content of substituted donor elements and acceptor elements satisfies a range of more than 0 mol % and less than or equal to 2 mol %, the dielectric constant of strontium titanate (SrTiO₃) or titanium dioxide (TiO₂) may be further improved.

When the total content of substituted donor elements and acceptor elements exceeds 2 mol %, may cause defects, thereby deteriorating dielectric characteristics, and may cause side effects by reducing the dispersibility of a material including the donor element and causing agglomeration. Additionally, it may excessively deteriorate insulating characteristics or cause dielectric loss (tan δ).

Meanwhile, although not particularly limited thereto, it may be preferable that a ratio of the substituted donor element to the acceptor element content (donor element: acceptor element) be 1:1 to 2:1.

In other words, it may be preferable that the content (mol %) of the substituted donor element and the content (mol %) of the substituted acceptor element may be the same, or that the content (mol %) of the substituted donor element may be twice the content (mol %) of the substituted acceptor element. Here, the ratio of substituted donor elements and acceptor elements may include a ±10% error range.

When the ratio of the substituted donor element to the acceptor element is 1:1 to 2:1, the dielectric constant of strontium titanate (SrTiO₃) or titanium dioxide (TiO₂) may be further improved, and no side effects may occur.

In the multilayer electronic component 100 according to some embodiments of the present disclosure, the dielectric layer 111 may include a first metal oxide 11 disposed at an triple point MP and a second metal oxide 12 disposed at a grain boundary GB, and an atomic percentage M1 of a first metal element included in the first metal oxide 11 may be higher than an atomic percentage M2 of a second metal element included in the second metal oxide 12.

The dielectric layer 111 may include the first metal oxide 11 at the triple point MP and the second metal oxide 12 at the grain boundary GB, and since the atomic percentage M1 of the first metal element included in the first metal oxide 11 is higher than the atomic percentage M2 of the second metal element included in the second metal oxide 12, the resistivity characteristics may be improved.

The high dielectric constant materials as mentioned above, such as strontium titanate (SrTiO₃) or titanium dioxide (TiO₂) substituted with donor or acceptor elements, the dielectric characteristics may be excellent, but the resistivity characteristics may be inferior.

Accordingly, as the dielectric layer 111 includes the first metal oxide 11 and the second metal oxide 12, thereby improving the resistivity characteristics, the multilayer electronic component 100 with improved high dielectric constant and resistivity characteristics may be provided, and in the case of titanium dioxide (TiO₂), the resistivity characteristics may be further improved.

More specifically, for example, in the dielectric layer 111 including strontium titanate (SrTiO₃) or titanium dioxide (TiO₂) substituted with a donor element or an acceptor element as a main component, the multilayer electronic component 100 including the first metal oxide 11 disposed at the triple point MP and the second metal oxide 12 disposed at the grain boundary GB may have a resistivity improved by 10⁵Ω or more compared to a multilayer electronic component not including the first metal oxide 11 disposed at the triple point MP and the second metal oxide 12 disposed at the grain boundary GB.

In the present disclosure, the first metal element included in the first metal oxide 11 and the second metal element included in the second metal oxide 12 may include at least one selected from a group consisting of, for example, Si, Al, Nb, Ta, Mo, V, Mg, In, Sn, Cu, Ni, Cr, Mn, Sb, Ga and Ti (may include ITO, FTO, or the like.), preferably may include at least one selected from a group consisting of Si and Al, and more preferably may include Si. However, it is not particularly limited thereto, and any metallic material able to improve resistivity characteristics may be included.

Additionally, the first metal element and the second metal element may be the same or different, or in a case where a plurality of metal elements are included, only some of the metals may be the same, but not particularly limited thereto.

Meanwhile, although not particularly limited thereto, for example, regarding the atomic percentage M1 of the first metal element included in the first metal oxide 11 and the atomic percentage M2 of the second metal element included in the second metal oxide 12, a difference (M1−M2) between the atomic percentage M1 of the first metal element included in the first metal oxide 11 and the atomic percentage M2 of the second metal element included in the second metal oxide 12 may be 10 at % or more.

For specific example, the atomic percentage M1 of the first metal element included in the first metal oxide 11 may be 70 at % or more, and the atomic percentage M2 of the second metal element included in the second metal oxide 12 may be less than 30 at %.

In the present disclosure, the atomic percentage at % of the first metal element included in the first metal oxide 11 and the atomic percentage at % of the second metal element included in the second metal oxide 12 may be determined, for example, the atomic percentage at % value of the metal element to be measured through EDS analysis mode from an image obtained by photographing cross-sections of the capacitance formation portion Ac using SEM, TEM, or STEM in the first and second direction.

For a more specific example, the atomic percentage at % value of the first metal element contained in the first metal oxide 11 may be obtained by averaging the atomic percentages at % of the first metal element detected through EDS analysis at 5 points within one first metal oxide 11. In addition, when photographing a certain region of the capacitance formation portion Ac, in case a plurality of first metal oxides 11 are detected, the atomic percentages at % of the plurality of first metal oxides 11 included in a region are measured and obtained by the above-described method, and then the average atomic percentages at % of the plurality of first metal oxides 11 may be averaged to obtain the average atomic percentages at % of the plurality of first metal oxides 11. In this case, when the average atomic percentage at % value of the plurality of first metal oxides 11 is 70 at % or more, it may be a more preferable case in which the resistivity characteristics may be improved.

Although the first metal oxide 11 was explained as an example, it is obvious that the atomic percentage at % of the second metal element included in the second metal oxide 12 may also be obtained using the same method.

A thickness td of the dielectric layer 111 may not be limited to any particular example.

In order to ensure reliability of the multilayer electronic component 100 under a high-voltage environment, the thickness td of the dielectric layer may be 10.0 μm or less. Additionally, in order to implement miniaturization and high capacitance of the multilayer electronic component 100, the thickness td of the dielectric layer may be 3.0 μm or less. In order to implement ultra-miniaturization and high capacitance more easily, the thickness td of the dielectric layer may be 1.0 μm or less, preferably 0.6 μm or less, and more preferably 0.4 μm or less.

In this case, the thickness td of the dielectric layer may be the thickness of at least one of a plurality of dielectric layers, or may include the thickness of the entirety of the dielectric layers.

Here, the thickness td of the dielectric layer may refer to the thickness td of the dielectric layer disposed between first and second internal electrodes 121 and 122.

Meanwhile, the thickness td of the dielectric layer may refer to a size of the dielectric layer 111 in the first direction.

Additionally, the thickness td of a dielectric layer may refer to an average thickness td of one dielectric layer, or may refer to an average thickness td of a plurality of dielectric layers.

The average size, in the first direction, of the dielectric layer 111 may be measured by scanning an image of a cross-sections of a body 110 in the first and second direction using a scanning electron microscope (SEM) with a magnification of 10,000×. More specifically, the average size, in the first direction, of one dielectric layer may refer to an average value calculated by measuring the size, in the first direction, of one dielectric layer at 10 points at an equal distance in the second direction in a scanned image. The 10 points at an equal distance may be specified in the capacitance formation portion Ac. In addition, by extending this measurement of the average value to 10 dielectric layers, the average size, in the first direction, of the dielectric layers may be further generalized.

The internal electrodes 121 and 122 may be alternately stacked with the dielectric layer 111.

The internal electrodes 121 and 122 may include a first internal electrode 121 and a second internal electrode 122, the first and second internal electrodes 121 and 122 may be alternately disposed to face each other with the dielectric layer 111 included in the body 110 interposed therebetween, and may be exposed to the third and fourth surfaces 3 and 4 of the body 110, respectively.

More specifically, the first internal electrode 121 may be spaced apart from the fourth surface 4 and may be exposed through the third surface 3, and the second internal electrode 122 may be spaced apart from the third surface 3 and may be exposed through the fourth surface 4. The first external electrode 131 may be disposed on the third surface 3 of the body 110 and may be connected to the first internal electrode 121, and a second external electrode 132 may be disposed on the fourth surface 4 of the body 110 and may be connected to the second internal electrode 122.

That is, the first internal electrode 121 may not be connected to the second external electrode 132 and may be connected to the first external electrode 131, and the second internal electrode 122 may not be connected to the first external electrode 131 and may be connected to the second external electrode 132. In this case, the first and second internal electrodes 121 and 122 may be electrically separated from each other by the dielectric layer 111 disposed therebetween.

Meanwhile, the body 110 may be formed by alternately stacking a first ceramic green sheet printed with a paste for a first internal electrode, which may be the first internal electrode 121, and a second ceramic green sheet printed with a paste for a second internal electrode, which may be the second internal electrode 122 and then firing the sheets.

The material forming the internal electrodes 121 and 122 is not particularly limited, and a material having excellent electrical conductivity may be used. For example, the internal electrodes 121 and 122 may include one or more selected from the group consisting of nickel (Ni), copper (Cu), palladium (Pd), silver (Ag), gold (Au), platinum (Pt), tin (Sn), tungsten (W), titanium (Ti), and alloys thereof.

Additionally, the internal electrodes 121 and 122 may be formed by printing conductive paste for internal electrodes including one or more selected from the group consisting of nickel (Ni), copper (Cu), palladium (Pd), silver (Ag), gold (Au), platinum (Pt), tin (Sn), tungsten (W), titanium (Ti) and alloys thereof on a ceramic green sheet. A screen printing method or a gravure printing method may be used as a method of printing the conductive paste for internal electrodes, but an embodiment thereof is not limited thereto.

Meanwhile, thickness the of the internal electrodes 121 and 122 may not be limited to any particular example.

In order to assure reliability under a high-voltage environment of the multilayer electronic component 100, the thickness the of the internal electrode may be 3.0 μm or less. Additionally, in order to implement miniaturization and high capacitance of the multilayer electronic component 100, the thickness the of the internal electrode may be 1.0 μm or less. In order to more easily implement ultra-miniaturization and high capacitance, the thickness the of the internal electrode may be 0.6 μm or less, and more preferably 0.4 μm or less.

In this case, the thickness the of the internal electrode may be a concept including at least one thickness the of a plurality of internal electrodes, or may be a concept including the thickness the of the entirety of internal electrodes.

Here, the thickness the of the internal electrode may refer to the size in the first direction of the internal electrodes 121 and 122.

In addition, the thickness the of the internal electrode may refer to an average thickness the of one internal electrode, or may refer to an average thickness the of a plurality of internal electrodes.

The average size, in the first direction, of the internal electrodes 121 and 122 may be measured by scanning an image of cross-sections of the body 110 in the first and second direction using a scanning electron microscope (SEM) with a magnification of 10,000×. More specifically, an average size of the internal electrode in the first direction may refer to an average value calculated by measuring the size, in the first direction, of one dielectric layer at 10 points at an equal distance in the second direction in the scanned image. The 10 points at an equal distance may be designated in the capacitance formation portion Ac. In addition, by extending the measurement of the average value to 10 internal electrodes, the average size of the plurality of internal electrodes in the first direction may be further generalized.

Meanwhile, in some embodiments of the present disclosure, the thickness td of at least one of the plurality of dielectric layers and the thickness the of at least one of the plurality of internal electrodes may satisfy 2×te<td.

In other words, the thickness td of one of the dielectric layers may be greater than twice the thickness the of one of the internal electrodes. Preferably, the average thickness td of the plurality of dielectric layers may be greater than twice the average thickness the of the plurality of internal electrodes.

In general, a reliability issue due to a decrease in the breakdown voltage (BDV) under a high-voltage environment may be a major issue for high-voltage electronic components.

Accordingly, in order to prevent a decrease in the breakdown voltage under a high-voltage environment, by configuring the average thickness td of the dielectric layer to be greater than twice the average thickness the of the internal electrodes, the thickness of the dielectric layer, which is the distance between the internal electrodes, may be increased, and breakdown voltage properties may be improved.

When the average thickness td of the dielectric layer is less than twice the average thickness the of the internal electrodes, the average thickness of the dielectric layer, which is the distance between the internal electrodes, may be reduced, such that the breakdown voltage may be decrease and a short may occur between the internal electrodes.

Meanwhile, the body 110 may include cover portions 112 and 113 disposed on both end-surfaces of the capacitance formation portion Ac in the first direction.

Specifically, the body 110 may include a first cover part 112 disposed on one surface of the capacitance formation portion Ac in the first direction and a second cover portion 113 disposed on the other surface of the capacitance formation portion Ac in the first direction, and more specifically, the body 110 may include an upper cover portion 112 disposed in the upper portion of the capacitance formation portion Ac in the first direction and a lower cover portion 113 disposed on a lower portion of the capacitance formation portion Ac in the first direction.

The first cover portion 112 and the second cover portion 113 may be formed by disposing or stacking a single second dielectric layer or two or more second dielectric layers on the upper and lower surfaces of the capacitance formation portion Ac in the first direction, respectively, and may prevent damages to the internal electrodes 121 and 122 due to physical or chemical stress.

The first cover portion 112 and the second cover portion 113 may not include internal electrodes 121 and 122 and may include the same dielectric material as that of the first dielectric layer 111. That is, the first cover portion 112 and the second cover portion 113 may include a ceramic material, for example, a barium titanate (BaTiO₃) ceramic material.

Meanwhile, the thickness tc of the cover portions 112 and 113 may not need to be particularly limited, and hereinafter, a description of the thickness tc of the cover portions 112 and 113 may refer to the thickness tc of each of the first cover portion 112 and the second cover portion 113.

However, to easily implement miniaturization and high capacitance of the multilayer electronic component, the thickness tc of the cover portion may be 50 μm or less, preferably 30 μm or less, and more preferably, the thickness may be 20 μm or less in ultra-small products.

Here, the thickness tc of the cover portion may refer to the size of the cover portions 112 and 113 in the first direction.

In addition, the thickness tc of the cover portion may refer to an average thickness tc of each of the first and second cover portions 112 and 113, or may refer to an average thickness tc of the first and second cover portions 112 and 113.

The average size of the cover portion in the first direction may be measured by scanning an image of cross-sections of a body 110 in the first and second directions using a scanning electron microscope (SEM) at 10,000× magnification. More specifically, it may refer to an average value calculated by measuring the sizes, in the first direction, at 10 points at an equal distance in the second direction in the scanned image of one cover portion.

In addition, the average size, in the first direction, of the cover portion measured by the above-described method may be substantially the same as the average size, in the first direction, of the cover portion in the cross-sections of the body 110 in the first and third direction.

Meanwhile, the multilayer electronic component 100 may include a side margin regions 114′ and 115′ in a region of the internal electrodes 121 and 122 in the third direction.

More specifically, the side margin regions 114′ and 115′ may include a first side margin region 114′ disposed between the internal electrodes 121 and 122 and the fifth surface 5 and a second side margin region 115′ disposed between the internal electrodes 121 and 122 and the sixth surface 6.

As illustrated, the side margin regions 114′ and 115′ may refer to a region between both end-surfaces of the first and second internal electrodes 121 and 122 in the third direction and a boundary surface of the body 110 with respect to the cross-sections of the body 110 in the first and third direction.

The side margin regions 114′ and 115′ may refer to a ceramic green sheet region other than the internal electrodes 121 and 122 when the paste for the internal electrode is applied to the ceramic green sheet applied to the capacitance formation portion Ac, except for a region in which the side margin regions 114′ and 115′ are formed.

The side margin regions 114′ and 115′ may basically prevent damages to the internal electrodes 121 and 122 due to physical or chemical stress.

The first side margin region 114′ and the second side margin region 115′ may not include the internal electrodes 121 and 122, and may include the same material as the first dielectric layer 111, and may correspond to, for example, a portion of the first dielectric layer 111. That is, the first side margin region 114′ and the second side margin region 115′ may include a ceramic material, for example, a barium titanate (BaTiO₃) ceramic material.

Meanwhile, the multilayer electronic component 100 may include side margin portions 114 and 115 disposed on both end-surfaces of the body 110 in the third direction.

More specifically, the side margin portions 114 and 115 may include a first side margin portion 114 disposed on the fifth side 5 of the body 110 and a second side margin portion 115 disposed on the sixth side 6 of the body 110.

The side margin portions 114 and 115 may be formed by applying a conductive paste to the ceramic green sheet applied to the capacitance formation portion Ac, other than the region in which the side margin portions 114 and 115 may be formed, cutting the internal electrodes 121 and 122 after stacking to be exposed to the fifth and sixth surfaces 5 and 6 of the body 110 so as to suppress a step difference caused by the internal electrodes 121 and 122, and disposing or stacking a single third dielectric layer or two or more third dielectric layers on both end-surfaces of the capacitance formation portion Ac in the third direction.

The side margin portions 114 and 115 may prevent damage to the internal electrodes 121 and 122 due to physical or chemical stress.

The first side margin portions 114 and the second side margin portion 115 may not include the internal electrodes 121 and 122, and may include the same material as the dielectric layer 111. That is, the first side margin portion 114 and the second side margin portion 115 may include a ceramic material, for example, a barium titanate (BaTiO₃)-based ceramic material.

Meanwhile, a width wm of the side margin portions 114 and 115 may not need to be limited to any particular example, and hereinafter, the description of the width wm of the side margin portions 114 and 115 may refer to a width wm of the first side margin portion 114 and the second side margin portion 115, respectively.

However, to easily implement miniaturization and high capacitance of the multilayer electronic component 100, the width wm of the side margin portion may be 50 μm or less, preferably 30 μm or less, and may be more preferably 20 μm or less in ultra-small products.

In this case, the width wm of the side margin portion may refer to the size of the side margin portions 114 and 115 in the third direction.

Additionally, the width wm of the side margin portions 114 and 115 may refer to an average width wm of each of the first and second side margin portions 114 and 115, or may refer to an average width wm of the first and second side margin portions 114 and 115.

The average size of the side margin portions 114 and 115 in the third direction may be measured by scanning an image of cross-sections of the body 110 in the first and third directions using a scanning electron microscope (SEM) at 10,000× magnification. More specifically, the average size may be an average value measured from the sizes in the third direction at 10 points at an equal distance in the first direction in a scanned image of one of the side margin portions.

In some embodiments of the present disclosure, the multilayer electronic component 100 may have two external electrodes 131 and 132, but the number or shape of the external electrodes 131 and 132 may be varied depending on the forms of the internal electrodes 121 and 122 or other purposes.

The external electrodes 131 and 132 may be disposed on the body 110 and may be connected to the internal electrodes 121 and 122.

More specifically, the external electrodes 131 and 132 may be disposed on the third and fourth surfaces 3 and 4 of the body 110, respectively, and may include first and second external electrodes 131 and 132 connected to the first and second internal electrodes 121 and 122, respectively. That is, the first external electrode 131 may be disposed on the third surface 3 of the body and may be connected to the first internal electrode 121, and the second external electrode 132 may be disposed on the fourth surface 4 of the body and may be connected to the second internal electrode 122.

Additionally, the external electrodes 131 and 132 may extend and be disposed on portions of the first and second surfaces 1 and 2 of the body 110, or may extend and be disposed on a portion of the fifth and sixth surfaces 5 and 6 of the body 110. That is, the first external electrode 131 may be disposed on the third surface 3 of the body 110 and a portion of the first, second, fifth, and sixth surfaces 1, 2, 5, and 6 of the body 110, and the second external electrode 132 may be disposed on the fourth surface 4 of the body 110 and a portion of the first, second, fifth, and sixth surfaces 1, 2, 5, and 6 of the body 110.

Meanwhile, the external electrodes 131 and 132 may be formed of any material having electrical conductivity, such as metal, and a specific material may be determined in consideration of electrical characteristics and structural stability, or the like, and may further have a multilayer structure.

For example, the external electrodes 131 and 132 may include an electrode layer disposed on the body 110 and a plating layer disposed on the electrode layer. In this case, the electrode layer may include a first electrode layer disposed on the body and a second electrode layer disposed on the first electrode layer, and the plating layer may include a first plating layer disposed on the electrode layer and a second plating layer disposed on the first plating layer, but is not particularly limited thereto. The electrode layer and plating layer will be described in more detail below.

For a more specific example of the electrode layers 131a, 132a, 131b, and 132b, the electrode layers 131a, 132a, 131b, and 132b may include the first electrode layers 131a and 132a, which is a sintered electrode including a first conductive metal and glass, or a second electrode layer 131b and 132b, which is a resin-based electrode including a second conductive metal and resin.

Here, the conductive metal included in the first electrode layers 131a and 132a may be referred to as the first conductive metal, and the conductive metal included in the second electrode layers 131b and 132b may be referred to as the second conductive metal. In this case, the first conductive metal and the second conductive metal may be the same or different from each other, and in the case in which a plurality of conductive metals are included, only a portion thereof may include the same conductive metal, but is not particularly limited thereto.

In addition, the electrode layers 131a, 132a, 131b, and 132b may be formed in a form in which the first electrode layers 131a and 132a, which are sintered electrode layers, and the second electrode layers 131b and 132b, which are resin-based electrode layers, may be sequentially formed on the body 110.

The electrode layers 131a, 132a, 131b, and 132b may be formed by transferring a sheet including a conductive metal onto the body, or may be formed by transferring a sheet including a conductive metal onto a sintered electrode. Alternatively, the electrode layers 131a, 132a, 131b, and 132b may be formed by applying a conductive paste for an external electrode including a conductive metal to the body 110 and performing sintering, or by dipping the body 110 in a conductive paste for an external electrode including a conductive metal, but is not particularly limited thereto.

A material having excellent electrical conductivity may be used as the conductive metal included in the electrode layers 131a, 132a, 131b, and 132b, and for example, the conductive metal may include one or more selected from a group consisting of nickel (Ni), copper (Cu), palladium (Pd), silver (Ag), gold (Au), platinum (Pt), tin (Sn), tungsten (W), titanium (Ti), and alloys thereof, but is not particularly limited thereto.

In some embodiments of the present disclosure, the electrode layers 131a, 132a, 131b, and 132b may have a two-layer structure including the first electrode layers 131a and 132a and the second electrode layers 131b and 132b, and more specifically, the external electrodes 131 and 132 may include the first electrode layers 131a and 132a including a first conductive metal and glass, and the second electrode layers 131b and 132b disposed on the first electrode layers 131a and 132a including a second conductive metal and resin.

The first electrode layers 131a and 132a may improve bonding with the body 110 by including glass, and the second electrode layers 131b and 132b may improve bending strength by including resin.

The first conductive metal included in the first electrode layers 131a and 132a is not particularly limited as long as a material may be electrically connected to the internal electrodes 121 and 122 to form a capacitance, and for example, at least one selected from the group consisting of nickel (Ni), copper (Cu), palladium (Pd), silver (Ag), gold (Au), platinum (Pt), tin (Sn), tungsten (W), titanium (Ti), and alloys thereof may be included.

The first electrode layers 131a and 132a may be formed by applying a conductive paste prepared by adding a glass frit to first conductive metal particles and sintering.

The second conductive metal included in the second electrode layers 131b and 132b may electrically connect to the first electrode layers 131a and 132a.

The second conductive metal included in the second electrode layers 131b and 132b is not particularly limited as long as a material may be electrically connected to the first electrode layers 131a and 132a, and at least one selected from the group consisting of nickel (Ni), copper (Cu), palladium (Pd), silver (Ag), gold (Au), platinum (Pt), tin (Sn), tungsten (W), titanium (Ti), and alloys thereof may be included.

The second conductive metal included in the second electrode layers 131b and 132b may include at least one of spherical particles or flake-shaped particles. That is, the second conductive metal may be composed of only flake-shaped particles, only spherical particles, or a mixed form of flake-shaped particles and spherical particles. Here, the spherical particles may also include shapes not completely spherical, and for example, shapes having a length ratio of a major axis to a minor axis (major axis/minor axis) of 1.45 or less. The flake-shaped particles may refer to particles having a flat and elongated shape, and are not particularly limited, but for example, a length ratio of the major axis to the minor axis (major axis/minor axis) may be 1.95 or more. The lengths of the major and minor axes of the spherical particles and flake-shaped particles may be measured from images obtained by scanning a cross-section in the first and second directions taken from the center portion of the third direction of the multilayer electronic component using a scanning electron microscope (SEM).

The resin included in the second electrode layer 131b and 132b may assure bonding and absorbing impact, and is not particularly limited as long as the resin may be mixed with the second conductive metal particles to form a paste, for example, the resin may include epoxy-based resin.

Additionally, the second electrode layers 131b and 132b may further include an intermetallic compound.

By including an intermetallic compound, electrical connectivity with the first electrode layers 131a and 132a may be further improved. The intermetallic compound may improve electrical connectivity by connecting a plurality of second conductive metal particles, and may surround and connect the plurality of second conductive metal particles.

In this case, the intermetallic compound may include a metal having a melting point lower than a curing temperature of the resin. That is, since the intermetallic compound includes a metal having the melting point lower than the curing temperature of the resin, the metal having the melting point lower than the curing temperature of the resin may be melted during a drying and curing process, and may form an intermetallic compound with a portion of the metal particle and may surround the metal particles. In this case, the intermetallic compound may preferably include a low melting point metal of 300° C. or less.

For example, it may include Sn having a melting point of 213 to 220° C. During the drying and curing process, Sn may melt, and the melted Sn may wet high-melting point metal particles such as Ag, Ni, or Cu by capillary action, and may react with a portion of the Ag, Ni, or Cu metal particles and form intermetallic compounds such as Ag₃Sn, Ni₃Sn₄, Cu₆Sns, and Cu₃Sn. Ag, Ni or Cu not participating in the reaction may remain in a form of metal particles.

Accordingly, the plurality of second conductive metal particles may include one or more of Ag, Ni and Cu, and the intermetallic compound may include one or more of Ag₃Sn, Ni₃Sn₄, Cu₆Sns and Cu₃Sn.

The plating layer 131c and 132c may improve mounting characteristics.

The type of the plating layers 131c and 132c are not particularly limited, and may be a single layer of the plating layers 131c and 132c including one or more selected from the group consisting of nickel (Ni), tin (Sn), silver (Ag), palladium (Pd), and alloys thereof, or a plurality of layers may be formed.

For a more specific example of the plating layers 131c and 132c, the plating layers 131c and 132c may be Ni plating layers or Sn plating layers, and Ni plating layers and Sn plating layers may be sequentially formed on the electrode layer, and the Sn plating layers, Ni plating layers, and Sn plating layer are sequentially formed. Additionally, the plating layers 131c and 132c may include a plurality of Ni plating layers and/or a plurality of Sn plating layers.

A size of the multilayer electronic component 100 may not be specifically limited.

However, to implement both miniaturization and high capacitance, at the same time, thickness of the dielectric layer and internal electrodes must be reduced to increase the number of layers, such that the effect according to the present disclosure may be more noticeable in the multilayer electronic component 100 having a size 3216 (length×width: 3.2 mm×1.6 mm, length and width satisfy an error within ±5%) or less.

Although the embodiments of the present disclosure have been described in detail above, the present disclosure is not limited by the above-described embodiments and the accompanying drawings, and is intended to be limited by the appended claims. Therefore, various forms of substitution, modification, and change will be possible by those skilled in the art within the scope of the technical spirit of the present disclosure described in the claims, which also falls within the scope of the present disclosure.

In addition, the expression ‘one embodiment’ used in the present disclosure does not mean the same embodiment, and is provided to emphasize and describe different unique characteristics. However, one embodiment presented above is not excluded from being implemented in combination with features of another embodiment. For example, even if a matter described in one specific embodiment is not described in another embodiment, it can be understood as a description related to another embodiment, unless there is a description contradicting or contradicting the matter in the other embodiment.

Terms used in this disclosure are only used to describe one embodiment, and are not intended to limit the disclosure. In this case, singular expressions include plural expressions unless the context clearly indicates otherwise.

While example embodiments have been shown and described above, it will be apparent to those skilled in the art that modifications and variations could be made without departing from the scope of the present invention as defined by the appended claims.

What is claimed is:

1. A multilayer electronic component, comprising:
a body including:
a dielectric layer including SrTiO₃ or TiO₂ as a main component, wherein in a structure of SrTiO₃ or TiO₂, at least one of element sites excluding an oxygen element (O) is substituted with a donor element, and
internal electrodes alternately disposed with the dielectric layer in a first direction; and
an external electrode disposed on the body;
wherein the dielectric layer includes a plurality of dielectric grains, grain boundaries between adjacent dielectric grains, and triple points at a point at which three or more of the grain boundaries contact each other, a first metal oxide disposed at the triple points, and a second metal oxide disposed at the grain boundaries,
wherein an atomic percentage of a first metal element contained in the first metal oxide is higher than an atomic percentage of a second metal element contained in the second metal oxide.

2. The multilayer electronic component of claim 1, wherein the donor element includes at least one selected from the group consisting of Nb, Ta, Sb, Mo and V.

3. The multilayer electronic component of claim 1, wherein a content of the donor element is greater than 0 mol % and less than or equal to 2 mol %.

4. The multilayer electronic component of claim 1, wherein, SrTiO₃ or TiO₂ is further substituted with an acceptor element at least one of the element sites excluding an oxygen element (O).

5. The multilayer electronic component of claim 4, wherein the acceptor element includes at least one selected from the group consisting of Al, Ga, Mg, Zn, Sc, In, Yb, Er and Eu.

6. The multilayer electronic component of claim 4, wherein a content of the acceptor element is greater than 0 mol % and less than or equal to 1 mol %.

7. The multilayer electronic component of claim 4, wherein a total content of the donor element and acceptor element is greater than 0 mol % and less than or equal to 2 mol % with respect to a total amount of SrTiO₃ or TiO₂.

8. The multilayer electronic component of claim 4, wherein a ratio of the donor element to the acceptor element is 1:1 to 2:1.

9. The multilayer electronic component of claim 1, wherein a difference between the atomic percentage of the first metal element included in the first metal oxide and the atomic percentage of the second metal element included in the second metal oxide is 10 at % or more.

10. The multilayer electronic component of claim 1, wherein the atomic percentage of the first metal element contained in the first metal oxide is 70 at % or more, and the atomic percentage of the second metal element contained in the second metal oxide is less than 30 at %.

11. The multilayer electronic component of claim 1, wherein the first metal element included in the first metal oxide and the second metal element included in the second metal oxide include at least one selected from the group consisting of Si, Al, Nb, Ta, Mo, V, Mg, In, Sn, Cu, Ni, Cr, Mn, Sb, Ga and Ti.
